(19) United States
(12) Patent Application Publication
(10) Pub. No.: US 2008/0307447 A1
(43) Pub. Date: Dec. 11, 2008

(54) PRODUCTION METHOD OF SPINDLE MOTOR AND SPINDLE MOTOR

(75) Inventors: Masato GOMYO, Kyoto (JP); Yoichi SEKII, Kyoto (JP); Kazuyoshi SAITO, Kyoto (JP); Tadashi HASEGAWA, Kyoto (JP); Tsuyoshi KATO, Kyoto (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: NIDEC CORPORATION, Kyoto (JP)

(21) Appl. No.: 12/129,731

(22) Filed: May 30, 2008

(30) Foreign Application Priority Data
Jun. 6, 2007 (JP) 2007-150172
Jul. 18, 2007 (JP) 2007-186559

(51) Int. Cl. G11B 17/03; B32B 38/04

(52) U.S. Cl. 720/696; 156/250

(57) ABSTRACT

In a manufacturing method of a disk-driving spindle motor, a disc-support member includes a base portion and a positioning portion. The disc-support member is fixed to a hub member. The base portion is in contact with a lower surface of a disc. The positioning portion extends axially upwardly from the base portion, and is disposed around the center axis. The positioning portion is in contact with an inner circumferential face or an inner circumferential rim of the disc.

The disc-support member is preferably made from a resin material having a cutting resistance smaller than that of a metal material from which the hub member is made.

### BACKGROUND OF THE INVENTION

1. Field of the Invention

The present invention relates to a manufacturing method of a disk-driving spindle motor for rotating a disc such as a magnetic disc or an optical disk, and a spindle motor manufactured by the manufacturing method.

2. Description of the Related Art

A spindle motor for rotating a magnetic disc is mounted on a hard disk drive used in a personal computer, a car navigation, or the like.

FIG. 16 is a sectional view of an exemplary configuration of a conventional spindle motor taken along a plane including a center axis. As shown in FIG. 16, a conventional spindle motor 9 includes a stationary section 91 having a stator core 911 and a coil 912, and a rotor 92 having a rotor magnet 921. The spindle motor 9 generates torque by the action of a magnetic flux between the stator core 911 and the coil 912, and the rotor magnet 921, thereby rotating the rotor 92 about a center axis L.

The rotor 92 of the spindle motor 9 has a shaft 922 extending along the center axis L, and a hub member 923 which is fixed to the shaft 922 and radiates from the center axis L. The hub member 923 has carrying faces 923a and 923b for carrying a storage medium such as a magnetic disc 93. The spindle motor 9 carries the magnetic disc 93 in the condition where a lower surface and an inner circumferential face of the magnetic disc 93 abut against the carrying faces 923a and 923b, respectively, and the spindle motor 9 rotates the hub member 923 about the center axis L. Such a conventional spindle motor is disclosed in International Patent Publication No. 02/004825, for example.

The hub member 923 of the conventional spindle motor 9 is formed by cutting a metal member such as aluminum, stainless steel, or the like. Accordingly, the carrying faces 923a and 923b which are in contact with the magnetic disc 93 are also made from the above-mentioned metal member.

However, the cutting for the entire shape of the hub member 923 increases the working cost of the hub member 923, which prevents spindle motors from being manufactured at a low cost. In addition, the cutting is conventionally performed for the metal material of high cutting resistance, so that a cutting tool wears out in a relatively shorter time, and it is difficult to shorten the working time. These factors further increase the manufacturing cost of the spindle motors and deteriorate the productivity.

### SUMMARY OF THE INVENTION

One aspect of the present invention relates to a manufacturing method of a disk-driving spindle motor for rotating a disc having a hole at the center thereof.

The manufacturing method of the spindle motor includes the following steps.

The manufacturing method includes a disposing step of disposing a hub member rotating about a center axis and radially spreading around the center axis, and disposing a disc-support member including a base portion and a positioning portion protruding axially upwardly from the base portion, the disc-support member being formed from a material having a smaller cutting resistance than that of a material from which the hub member is formed.

The manufacturing method also includes a fixing step of fixing the disc-support member to the hub member.

The manufacturing method further includes a cutting step of cutting an upper surface of the base portion, thereby obtaining a first contact face which is in contact with a lower surface of the disc, and cutting an outer circumferential face of the positioning portion, thereby obtaining a second contact face which is in contact with an inner circumferential face or an inner circumferential rim of the disc, while the hub member is being rotated about the center axis.

According to one aspect of the present invention, the cutting is performed for the disc-support member of lower cutting resistance than that of the hub member, thereby obtaining the first contact face which is in contact with the flat portion of the disc and the second contact face which is in contact with the inner circumferential portion of the disc. In this way, the damage of the cutting tool due to the cutting resistance can be suppressed, and the first contact face and the second contact face can be obtained in a short time. Accordingly, the manufacturing cost of the spindle motor can be reduced.

In another aspect, the present invention relates to a disk-driving spindle motor for rotating a disk having a hole at the center thereof.

The disk-driving spindle motor includes: a stationary assembly; a hub member radially spreading around a center axis; and a bearing unit for supporting the hub member in a relatively rotatable manner with respect to the stationary assembly.

The disk-driving spindle motor further includes a disc-support member, fixed to the hub member, for supporting the disc (21). The disc-support member includes a base portion disposed around the center axis, the base portion being in contact with a lower surface of the disc, and a positioning portion which extends to an axially upper side from the base portion and is disposed around the center axis, the positioning portion being in contact with an inner circumferential face or an inner circumferential rim of the disc.

The disc-support member is made from a material having a cutting resistance smaller than that of a material from which the hub member is made.

According to another aspect of the present invention, the disc-support member is made from a material having a lower cutting resistance than that of the material from which the hub member is made. For this reason, the damage of a cutting tool due to the cutting resistance can be suppressed, and the cutting can be performed for the base portion and the positioning portion in a short time. Accordingly, the manufacturing cost of the spindle motor can be reduced, and the productivity of the spindle motor can be improved.

Other features, elements, advantages and characteristics of the present invention will become more apparent from the following detailed description of preferred embodiments thereof with reference to the attached drawings.

### BRIEF DESCRIPTION OF THE DRAWINGS

FIG. 1 is a sectional view of a disk driver taken along a plane including a center axis.

FIG. 2 is a sectional view of a spindle motor taken along a plane including the center axis.

FIG. 3 is a top view of a hub member and a disc-support member.

FIG. 4 is a sectional view illustrating a condition where the disc-support member is deformed by thermal expansion taken along a plane including the center axis.

FIG. 5 is a flowchart illustrating a manufacturing procedure of a spindle motor.

FIG. 6 is a flow chart illustrating a detailed procedure of a cutting process.

FIG. 7 is a diagram showing a condition of the spindle motor in the middle of the manufacturing.

FIG. 8 is a diagram showing a condition of the spindle motor in the middle of the manufacturing.

FIG. 9 is a diagram showing a condition of the spindle motor in the middle of the manufacturing.

FIG. 10 is a diagram showing a condition of the spindle motor in the middle of the manufacturing.

FIG. 11 is a diagram showing a cutting route for the disc-support member by means of a turning tool.

FIG. 12 is a diagram showing a cutting route for the disc-support member by means of the turning tool.

FIG. 13 is a diagram showing a cutting route for the disc-support member by means of the turning tool.

FIG. 14 is a diagram showing a condition of the spindle motor in the middle of the manufacturing.

FIG. 15 is a sectional view of a spindle motor in a modified embodiment taken along a plane including the center axis.

FIG. 16 is a sectional view illustrating an exemplary configuration of a conventional spindle motor taken along a plane including a center axis.

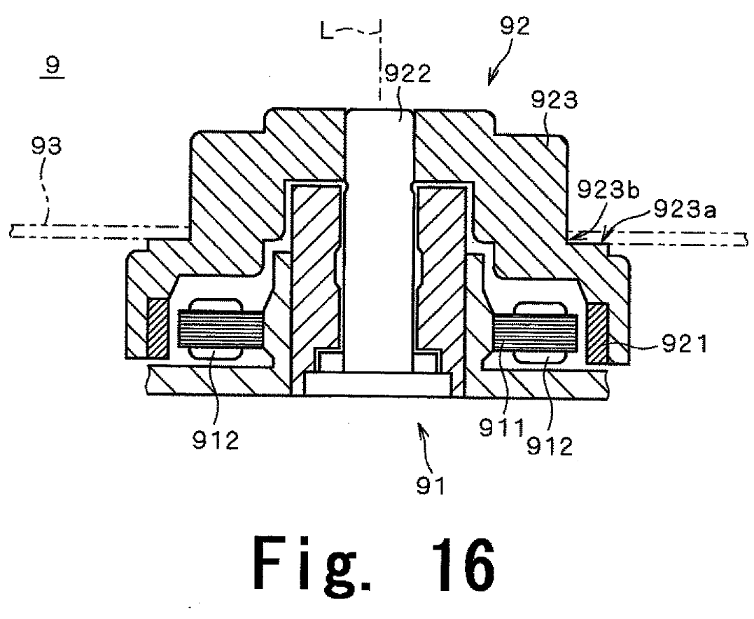

### DETAILED DESCRIPTION OF PREFERRED EMBODIMENTS

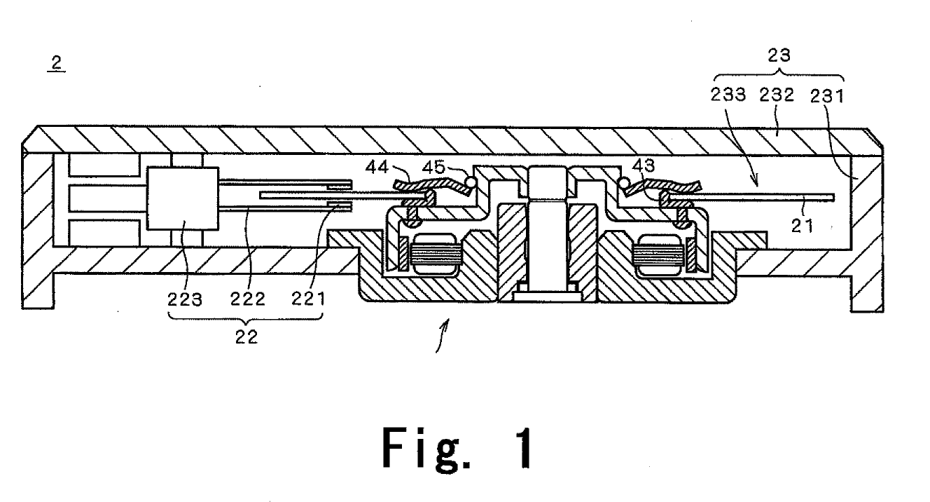

Referring to FIGS. 1 through 15, preferred embodiments of the present invention will be described in detail. It should be noted that in the explanation of the present invention, when positional relationships among and orientations of the different components are described as being up/down or left/right, ultimately positional relationships and orientations that are in the drawings are indicated; positional relationships among and orientations of the components once having been assembled into an actual device are not indicated. Meanwhile, in the following description, an axial direction indicates a direction parallel to a rotation axis, and a radial direction indicates a direction perpendicular to the rotation axis.

FIG. 1 is a sectional view of a disk driver 2 furnished with a disc-driving spindle motor 1 according to one preferred embodiment of the present invention taken along a plane including a center axis. The disk driver 2 is a hard-disk driver for reading and writing information while a magnetic disc 21 is being rotated.

As shown in FIG. 1, the disk driver 2 includes a disc 21, a spindle motor 1, an access unit 22, and a housing 23. The disc 21 is a disc-like information storage medium having a hole at the center thereof. The spindle motor 1 holds and rotates the disc 21. The access unit 22 performs the reading and writing of information from and to the disc 21. The housing 23 accommodates the disc 21, the spindle motor 1, and the access unit 22 in an interior space 233 thereof, and segregates them from the exterior of the housing 23.

The housing 23 includes a cup-like first housing member 231 and a plate-like second housing member 232. The first housing member 231 has an opening in the upper portion thereof. On an inner bottom surface of the first housing member 231, the spindle motor 1 and the access unit 22 are placed. The second housing member 232 is joined to the first housing member 231 so as to cover the upper opening of the first housing member 231. With this configuration, the interior space 233 of the housing 23 is formed. The interior space 233 of the housing 23 is a clean space with extremely less dust and grime.

The disc 21 is placed on a disc-support member 43 of the spindle motor 1. The disc 21 is fixed to the spindle motor 1 by means of a damper 44 and a ring wire 45.

The access unit 22 includes a head 221, an arm 222, and a head moving mechanism 223. The head 221 accesses to the disc 21, so as to magnetically perform the reading and writing of information from and to the disc 21. The arm 222 moves along the disc 21 while supporting the head 221. The head moving mechanism 223 is provided at the side of the disc 21. The head moving mechanism 223 moves the arm 222, thereby relatively moving the head 221 with respect to the disc 21 and the spindle motor 1. Accordingly, the head 221 performs the access to a required portion of the surface of the disc 21 in a condition where the head 221 accesses to the rotating disc, so as to read and write information.

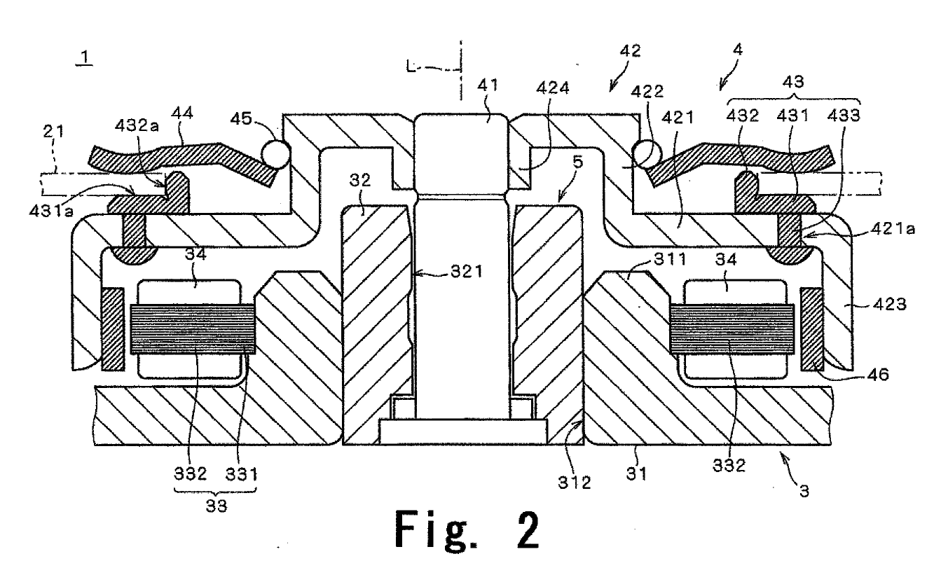

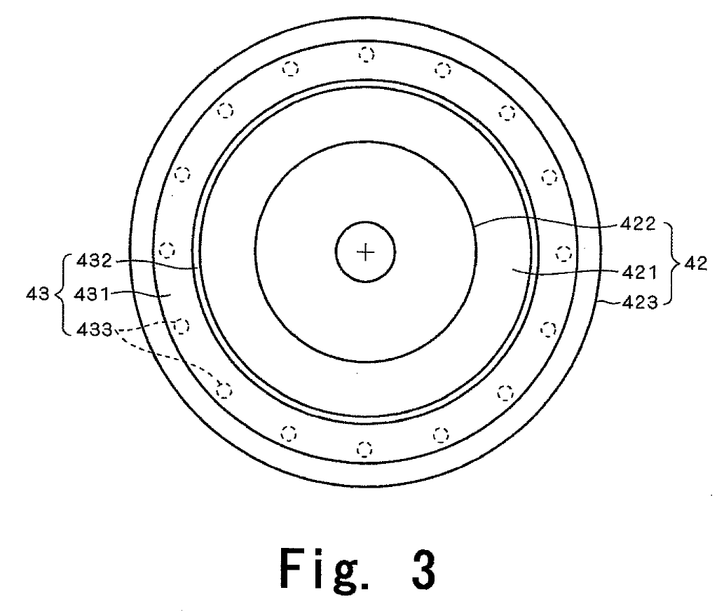

Next, the detailed configuration of the spindle motor 1 will be described. FIG. 2 is a sectional view of the spindle motor 1 taken along a plane including the center axis. FIG. 3 is a top view of a hub member 42 and a disc-support member 43 as components of the spindle motor 1.

The spindle motor 1 includes a stationary assembly 3, a rotor assembly 4, and a bearing unit 5. The stationary assembly 3 is fixed to the housing 23 of the disc driver 2. Onto the rotor assembly 4, the disc 21 is mounted, thereby rotating the disc 21 about a predetermined center axis L. The bearing unit 5 rotatably supports the rotor assembly 4.

The stationary assembly 3 includes a fixed frame 31, a sleeve 32, and a stator.

The fixed frame 31 is preferably made from a metal material such as aluminum. The fixed frame 31 is fixed to the housing 23 of the disk driver 2 by means of screws or the like. In the fixed frame 31, a substantially cylindrical bearing holder 311 is formed so as to protrude around the center axis L in an axial direction (i.e., in a direction along the center axis L, and so forth). On an inner circumferential side of the bearing holder 311 (i.e., an inner circumferential side with respect to the center axis L, and so forth), a frame through hole 312 extending in the axial direction is formed. On an outer circumferential surface of the bearing holder 311 (i.e., an outer circumferential side with respect to the center axis L, and so forth), a stator core 33 is attached.

In this preferred embodiment, the fixed frame 31 and the first housing member 231 are formed by using different members. However, the fixed frame and the first housing member may be formed as a single member. In such a case, the bearing holder is formed in the member which constitutes the fixed frame and the first housing member.

The bearing unit 5 includes a sleeve 32, a shaft 41, and lubricating oil retained between the sleeve 32 and the shaft 41. The sleeve 32 is inserted into the frame through hole 312 of the bearing holder 311, and fixed to the bearing holder 311 preferably by means of press fit, shrinkage fit, or the like. On the inner circumferential side of the sleeve 32, a sleeve through hole 321 into which the shaft 41 is inserted is formed. On an inner circumferential surface of the sleeve 32, herringbone dynamic-pressure grooves (not shown) for generating dynamic pressure in the lubricating oil retained between the outer circumferential surface of the shaft 41 and the inner circumferential surface of the sleeve 32 are formed.

The stator includes a stator core 33 and a coil 34. The stator core 33 includes a core back 331 attached to an outer circumferential surface of the bearing holder 311, and a plurality of tooth portions 332 protrudingly formed toward the radially outside from the core back 331 (i.e., in a radial direction with respect to the center axis L, and so forth). The stator core 33 is, for example, constituted by a laminated body in which electromagnetic steel sheets are axially laminated.

The coil 34 is wound around each tooth portion 332 of the stator core 33. The coil 34 is connected to a power supply which is not shown. When a current is applied to the coil 34 from the power supply, a magnetic flux is generated radially in the tooth portions 332. The magnetic flux generated in the tooth portions 332 mutually acts with the magnetic flux of the rotor magnet 46, thereby generating a torque for rotating the rotor assembly 4 about the center axis L.

On the other hand, the rotor assembly 4 includes the shaft 41, the hub member 42, the disc-support member 43, the clamper 44, the ring wire 45, and the rotor magnet 46.

The shaft 41 is a substantially columnar member extending along the center axis L. The shaft 41 is inserted into the sleeve through hole 321 of the sleeve 32. The outer circumferential surface of the shaft 41 and the inner circumferential surface of the sleeve 32 are opposite to each other with a micro gap (several micrometers, for example) interposed therebetween. The micro gap is filled with lubricating oil. Accordingly, the shaft 41 can rotate about the center axis L while being held in the sleeve through hole 321. When the shaft 41 rotates, the lubricating oil is pressurized by the herringbone dynamic-pressure grooves formed on the inner circumferential surface of the sleeve 32. Accordingly, when the rotor assembly 4 spins, the shaft 41 is supported by the dynamic pressure induced by the dynamic-pressure grooves.

The hub member 42 is fixed to the shaft 41, so as to rotate together with the shaft 41. The hub member 42 is formed in a radially extending manner around the center axis L. In more detail, the hub member 42 includes a flat plate portion 421 spread along a plane orthogonal to the center axis L, a first cylindrical portion 422 protruding upwardly from a peripheral portion on an inner circumferential side of the flat plate portion 421, and a second cylindrical portion 423 vertically suspended from a peripheral portion on an outer circumferential side of the flat plate portion 421. On an inner circumferential side of the first cylindrical portion 422, a cylindrical joint portion 424 is formed. The joint portion 424 is attached to the shaft 41 preferably by means of press fit, shrinkage fit, or the like.

The hub member 42 is preferably formed by press working of a metal material such as aluminum, stainless steel, a cold-rolling steel plate (SPCC, SPCD, or SPCE, for example). The hub member 42 in FIG. 2 is formed from a metal material with magnetization, but the material is not limited to the metal material.

In order to prevent the generation of rust, nickel plating is performed on the surface of the hub member 42. In the flat plate portion 421 of the hub member 42, a plurality of hub through holes 421a for inserting leg portions 433 of the disc-support member 43 are formed.

The disc-support member 43 supports the disc 21 on the upper side of the hub member 42. The disc-support member 43 includes a base portion 431 fixed to the flat plate portion 421 of the hub member 42, and a positioning portion 432 axially protruding from a peripheral portion on the inner circumferential side of the base portion 431.

The base portion 431 and the positioning portion 432 are disposed circularly by enclosing the center axis L. On the upper face of the base portion 431 of the disc-support member 43, a first contact face 431a which is in contact with a lower surface of the disc 21 is formed. On the outer circumferential face of the positioning portion 432 of the disc-support member 43, a second contact face 432a which is in contact with an inner peripheral portion (an inner circumference or an inner periphery) of the disc 21 is formed.

When the disc is placed on the disc-support member 43, the lower surface of the disc 21 comes into contact with the first contact face 431a, thereby restricting the axial position of the disc 21, and the inner peripheral portion of the disc 21 comes into contact with the second contact face 432a, thereby restricting the position of the disc 21 in a plane perpendicular to the center axis L. The first contact face 431a and the second contact face 432a are annularly formed continuously in the circumferential direction, respectively. In this way, the disc-support member 43 can stably support the disc 21. In addition, the first contact face 431a and the second contact face 432a are cut faces which are precisely finished by cutting. Accordingly, the disc 21 can be rotated with high rotation accuracy.

The disc-support member 43 includes a plurality of leg portions 433 axially protruding from the lower surface of the base portion 431. The disc-support member 43 is joined to the hub member 42 by inserting the plurality of leg portions 433 into the plurality of hub through holes 421a of the hub member 42, and by fixing tip ends of the leg portions 433 which protrude from the lower side of the hub member 42 to the flat plate portion 421 by means of thermal welding, or the like.

The disc-support member 43 is made from a thermoplastic resin with lower cutting resistance than the metal material which constitutes the hub member 42. Accordingly, it is possible to suppress the damage of cutting tool due to the cutting resistance, and to perform the precise finishing for the disc-support member 43. Therefore, the manufacturing cost of the spindle motor 1 can be reduced, and the productivity of the spindle motor 1 can be increased.

The thermoplastic resins include polyacetal, nylon, and the like, for example. The components made from such thermoplastic resins exhibit lower cutting resistance as compared with the components made from metal materials, when they are worked by cutting under the same conditions. Accordingly, in the cutting process of the disc-support member 43 which will be described later, the disc-support member 43 can be cut in a short time with the suppressed damage of a turning tool 54. The base portion 431, the positioning portion 432, and the leg portions 433 are formed as a single member by injection molding of a molten resin.

Preferably, the thermoplastic resin which constitutes the disc-support member 43 substantially contains no filler such as glass fiber, or carbon fiber. In a conventional resin material, powder or fiber called as filler is sometimes added to a resin as a base for the purpose of improving the properties of the material. If such a resin material containing the filler is used, the filler may be exposed on the cut face, or the filler may be fallen off from the cut face, so that particles undesired for the disk driver may disadvantageously be generated. In this preferred embodiment, the thermoplastic resin which constitutes the disc-support member 43 substantially contains no filler. Accordingly, generation of extraneous substances caused by the filler can be suppressed.

However, if the kind of resin, the kind of filler, or the method of adding the filler may be appropriately selected, the falling of the filler can be suppressed. For this reason, the thermoplastic resin containing filler is not perfectly excluded as the material for the disc-support member in the present invention.

As described above, the disc-support member 43 is formed from a member different from the hub member 42. Accordingly, the hub member 42 and the disc-support member 43 can be formed inexpensively by using respectively suitable materials.

As shown in FIGS. 2 and 3, the positioning portion 432 of the disc-support member 43 is opposite to the first cylindrical portion 422 of the hub member 42 with a gap radially interposed therebetween. Therefore, even if the positioning portion 432 is expanded due to the heat generation in the operation or the increase in surrounding environment temperature, it is possible to prevent the positioning portion 432 from being in contact with the first cylindrical portion 422.

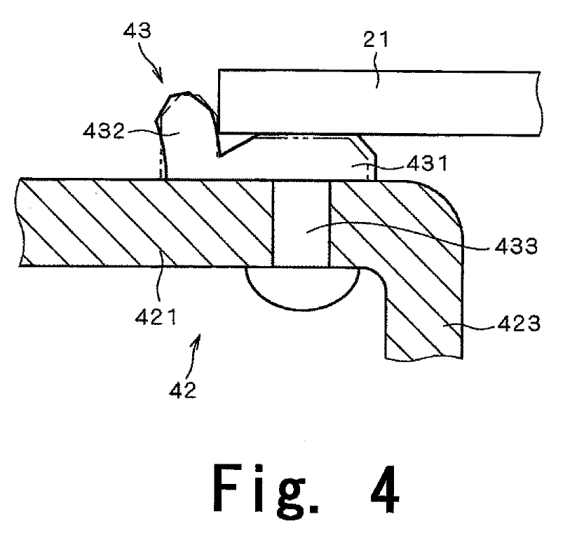

FIG. 4 is a sectional view illustrating how the disc-support member is deformed due to the thermal expansion in a slightly exaggerated manner. In FIG. 4, the disc-support member 43 before expansion is depicted by a phantom line, and the disc-support member 43 after the expansion is depicted by a solid line.

The thermoplastic resin which constitutes the disc-support member 43 exhibits a higher expansion coefficient than those of the materials constituting the hub member 42 and the disc 21. Accordingly, when the ambient temperature is increased due to the heat generation in the operation or the like, the disc-support member 43 will expand at a larger degree than the hub member 42 and the disc 21. However, as shown in FIGS. 2 and 3, the positioning portion 432 of the disc-support member 43 and the first cylindrical portion 422 of the hub member 42 are opposite to each other with a radial gap interposed therebetween. Therefore, when the disc-support member 43 expands, the positioning portion 432 can be slightly bent on the radially inner side, thereby accepting the deformation due to the expansion by the gap. Accordingly, an excessive pressure to the disc 21 from the positioning portion 432 in expansion can be suppressed.

The second contact face 432a is positioned on the radially inner side than the leg portions 433 joined to the hub member 42. Accordingly, the influence of the joining with the hub member 42 on the positioning portion 432 can be prevented. Moreover, since the leg portions 433 positioned on the radially outer side than the positioning portion 432 is fixed to the hub member 42, the displacement amount on the radially outer side of the positioning portion 432 due to the thermal expansion can be further suppressed.

The hub member 42 is preferably formed from a material having a linear expansion coefficient which is the same as or similar to that of the main material which constitutes the disc 21. For example, in the case where the main material constituting the disc 21 is aluminum, the hub member 42 is preferably formed from aluminum. In the case where the main material constituting the disc 21 is glass, the hub member 42 is preferably formed from a stainless steel having a linear expansion coefficient which is close to that of the glass. With such a configuration, the expansion rate of the hub member 42 can substantially agree with the expansion rate of the disc 21. As a result, the pressure applied to the disc 21 can be further reduced.

The clamper 44 is in contact with the upper surface of the disc 21 supported on the disc-support member 43, so as to fix the disc 21 on the disc-support member 43. The damper 44 is connected to the first cylindrical portion 422 of the hub member 42 via the ring wire 45. The damper 44 presses against the upper surface of the disc 21 due to the elastic force of the ring wire 45. The damper 44 and the ring wire 45 are formed from metal materials having conductivity, respectively. Accordingly, the clamper 44 and the ring wire 45 can transmit static electricity from the disc 21 to the hub member 42, thereby preventing the electrification of the disc 21 from occurring.

The rotor magnet 46 is fixed to an inner circumferential surface of the second cylindrical portion 423 of the hub member 42. The rotor magnet 46 is disposed circularly so as to enclose the center axis L. The rotor magnet 46 is radially opposed to the plurality of tooth portions 332 of the stator core 33.

In such a spindle motor 1, when a current is applied to the coil 34 of the stationary assembly 3, a magnetic flux in the radial direction is generated in the plurality of tooth portions 332 of the stator core 33. Then, a torque is generated by the action of the magnetic fluxes between the tooth portion 332 and the rotor magnet 46, thereby rotating the rotor assembly 4 about the center axis L with respect to the stationary assembly 4. The disc 21 supported on the disc-support member 43 also rotates about the center axis L together with the shaft 41, the hub member 42, and the disc-support member 43.

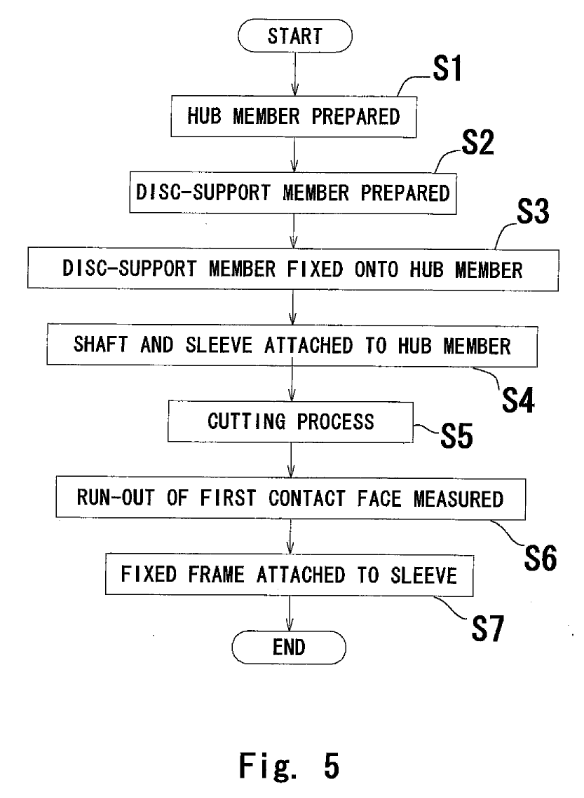

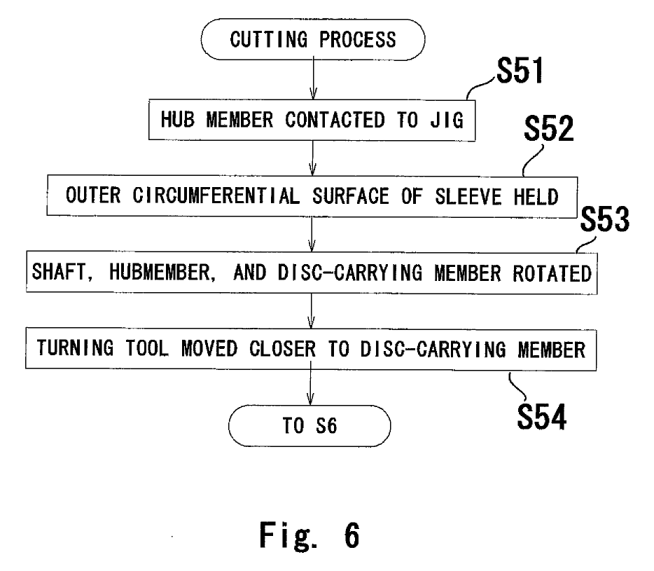

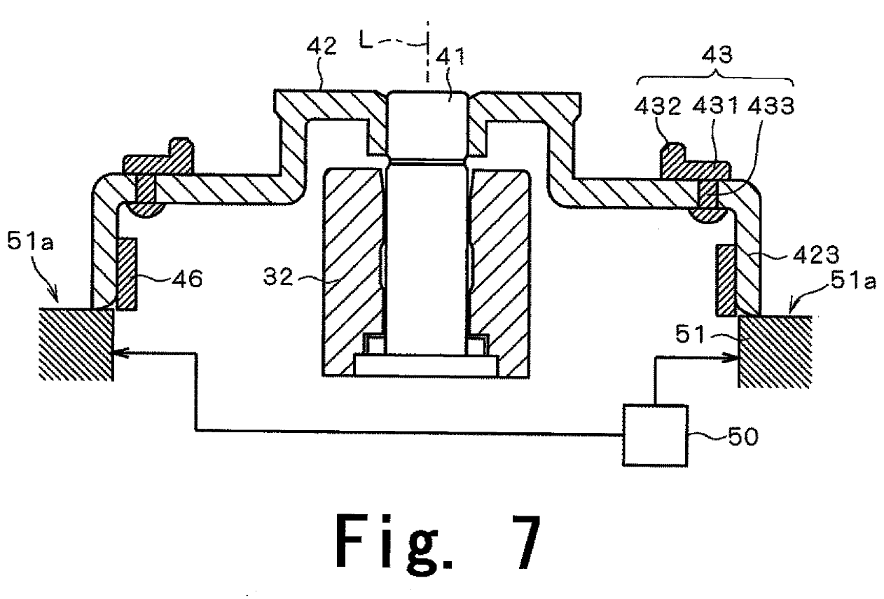

Next, the manufacturing method of the spindle motor 1 will be described. In the following description, FIGS. 5 to 10 are appropriately referred to. FIG. 5 is a flowchart illustrating the manufacturing procedure of the spindle motor 1. FIG. 6 is a flowchart illustrating the detailed procedure of the cutting process in the manufacturing procedure oh the spindle motor 1. FIGS. 7 to 10 show the conditions of the spindle motor 1 in the middle of the manufacturing thereof.

As shown in FIG. 5, a manufacturer prepares a hub member 42 (step S1). The hub member 42 is preferably formed by press working of the above-described metal material. The manufacturer performs nickel-plating for preventing damages such as rust on the surface of the hub member 42 obtained by the press working.

Next, the manufacturer prepares a disc-support member 43 (step S2). The disc-support member 43 is formed by injection molding of a thermoplastic resin such as polyacetal or nylon. At this time, the base portion 431 and the positioning portion 432 of the disc-support member 43 are formed so as to have slightly larger thicknesses than their final target values. The upper surface of the base portion 431 and the outer circumferential face of the positioning portion 432 are cut in step S5 as a subsequent step.

The step of preparing the hub member 42 (step S1) and the step of preparing the disc-support member 43 (step S2) may be performed in inverse order, or alternatively be performed in parallel.

Next, the manufacturer fixes the disc-support member 43 onto the hub member 42 (step S3). The manufacturer inserts a plurality of leg portions 433 of the disc-support member 43 into a plurality of hub through holes 421a of the hub member 42, and fixes tip ends of the leg portions 433 protruding from the lower surface side of the hub member 42 to a lower surface of a flat plate portion 421 by thermal welding.

Then, the manufacturer attaches a shaft 41 and a sleeve 32 to the hub member 42 (step S4). The manufacturer fixes an upper end portion of the shaft 41 to a joint portion 424 of the hub member 42 by means of press fit, shrinkage fit, or the like, and inserts a lower end portion of the shaft 41 into the sleeve 32. The manufacturer pours lubricating oil between the outer circumferential surface of the shaft 41 and the inner circumferential surface of the sleeve 32. Accordingly, the shaft 41, the hub member 42, and the disc-support member 43 are relatively rotatably supported with respect to the sleeve 32.

Thereafter, the manufacturer performs cutting for the disc-support member 43 by using a cutting device 50 (step S5). The detailed cutting process will be described with reference to the flowchart of FIG. 6. The manufacturer causes the lower end portion of the second cylindrical portion 423 of the hub member 42 to come into contact with an upper face 51a of a jig 51 which is part of the cutting device 50 (step S51, and see FIG. 7).

The upper face 51a of the jig 51 has given positional relationships with a chuck portion 52 and a turning tool 54 as the cutting tool which will be described later. Accordingly, when the hub member 42 comes into contact with the upper face 51a of the jig 51, the position and the posture of the hub member 42 in the cutting device 50 are restricted, thereby determining the positional relationships of the shaft 41, the hub member 42, the disc-support member 43, and the sleeve 32 with the chuck portion 52 and the turning tool 54.

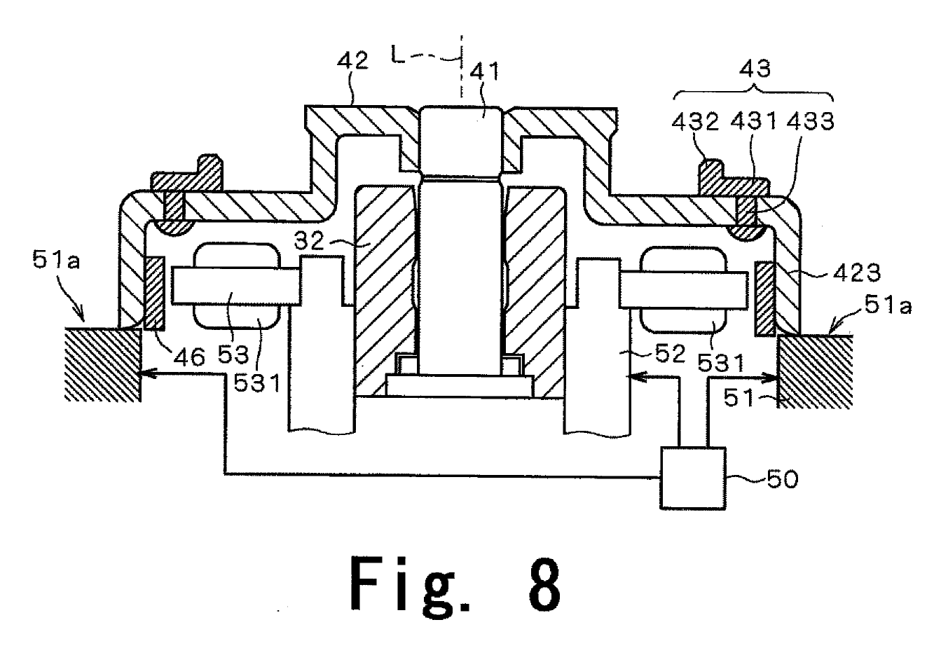

The cutting device 50 chucks the outer circumferential surface of the sleeve 32 by the chuck portion 52 in a condition where the hub member 42 is in contact with the jig 51 (step S52, and see FIG. 8). The positions and postures of the sleeve 32, the shaft 41, the hub member 42, and the disc-support member 43 are restricted by the jig 51, so that they are supported without shifting from the predetermined positions or tilting in the cutting device 50. Accordingly, the amount of working (i.e., the depth for cutting) of the disc-support member 43 is constant in step S54 which will be described later, and the cutting device 50 can cut the upper surface of the base portion 431 and the outer circumferential face of the positioning portion 432 with good accuracy. In addition, since the amount of working for the disc-support member 43 is constant, the cutting time can be shortened.

Especially in this preferred embodiment, instead of the sleeve 32, the hub member 42 is in contact with the jig 51. Accordingly, the disc-support member 43 can be placed in a predetermined position with good accuracy irrespective of the coupling accuracy of the sleeve 32 and the shaft 41.

Thereafter, the cutting device 50 moves downwardly the jig 51 for standby, and starts the shaft 41, the hub member 42, and the disc-support member 43 to rotate (step S53). The cutting device 50 rotates the shaft 41, the hub member 42, and the disc-support member 43 by utilizing a device-side stator 53 fixed on the outer circumferential side of the chuck portion 52 as part of the cutting device 50. That is, a current is applied to a coil 531 of the device-side stator 53, thereby generating a magnetic flux, and generating a torque between the device-side stator 53 and the rotor magnet 46.

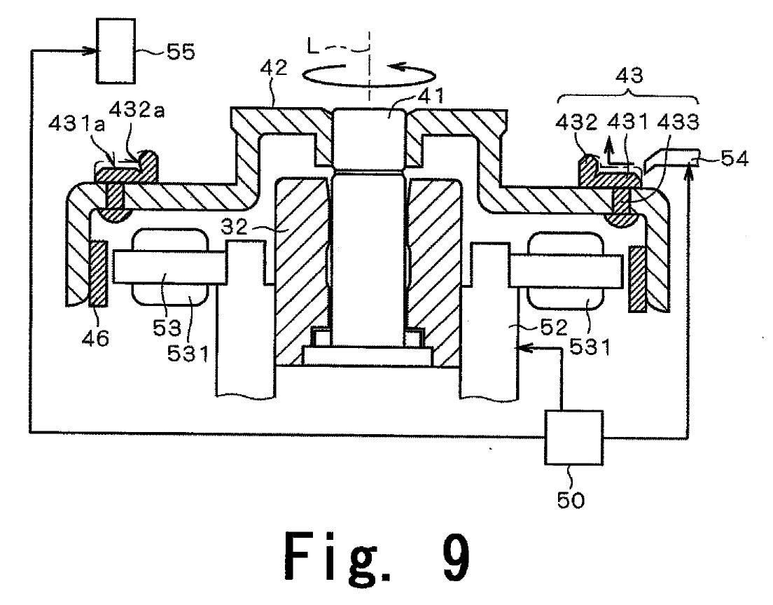

Moreover, the cutting device 50 moves the turning tool 54 closer to the disc-support member 43 while rotating the shaft 41, the hub member 42, and the disc-support member 43, thereby cutting the upper surface of the base portion 431 and the outer circumferential face of the positioning portion 432 of the disc-support member 43 (step S54, and see FIG. 9).

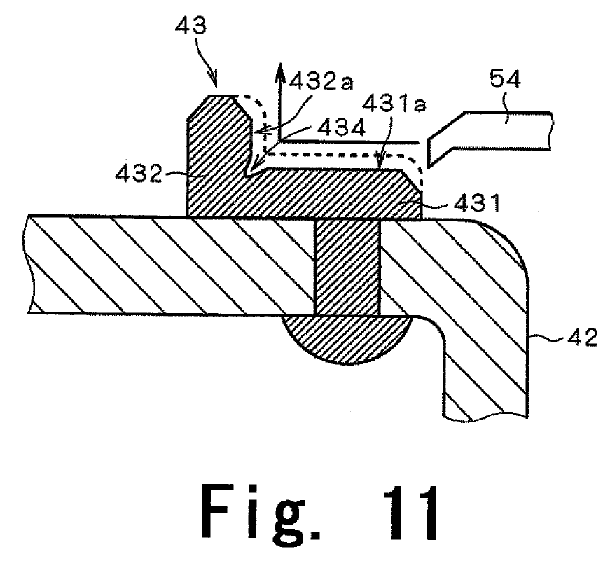

The turning tool 54 cuts the upper surface of the base portion 431 from the outer side to the inner side in the radial direction, as shown in FIG. 11. Thereafter, the turning tool 54 cuts the outer circumferential face of the positioning portion 432 from the lower side to the upper side in the axial direction. Accordingly, a first contact face 431a which is in contact with the lower surface of the disc 21 is formed on the upper surface of the base portion 431, and a second contact face 432a which is in contact with the inner circumferential portion of the disc 21 is formed on the outer circumferential face of the positioning portion 432.

As described above, in this manufacturing process, the disc-support member 43 is prepared as a member different from the hub member 42. By cutting the surface of the disc-support member 43, the first contact face 431a and the second contact face 432a are formed. Therefore, the first contact face 431a and the second contact face 432a can be obtained with good accuracy without grinding the nickel-plating on the hub member 42.

In addition, the amount of run-out of the second contact face 432b which will be described later in step S6 can be suppressed with high accuracy, so that the disc 21 can be attached to the hub member 42 with high accuracy, and the vibration in rotation of the rotor assembly 4 can be reduced. Accordingly, the track density on the disc 21 can be increased, and the recording density can also be increased.

Since the angularity of the first contact face 431a with respect to the center axis L can be realized with high accuracy, the disc 21 can be positioned in a direction orthogonal to the center axis with high accuracy even after the disc 21 is loaded. Therefore, the amount of lift of the head 221 with respect to the disc 21 (see FIG. 1) is stable, and the high-density recording can be realized. Herein, the angularity means the magnitude of deviation of the linear shape or the planar shape which should be perpendicular from a geometric line or a geometric plane perpendicular to a datum line or a datum plane.

The disc-support member 43 is made from a resin material having a smaller cutting resistance than that of the metal material which constitutes the hub member 42. For this reason, the first contact face 431a and the second contact face 432a can be obtained in a short time while the damage of the turning tool 54 due to the cutting resistance is suppressed. With such a configuration, the manufacturing cost of the spindle motor 1 can be reduced.

The cutting device 50 cuts the upper surface of the base portion 431 and the outer circumferential face of the positioning portion 432 of the disc-support member 43 while the shaft 41, the hub member 42, and the disc-support member 43 rotate about the center axis L. Accordingly, the first contact face 431a and the second contact face 432a can be formed with good accuracy at a desired angle (perpendicular to the center axis L, for example). That is, the angularity of the first contact face 431a and the second contact face 432a can be obtained with high accuracy.

The cutting device 50 continuously cuts the upper surface of the base portion 431 and the outer circumferential face of the positioning portion 432 by using the single turning tool 54. Accordingly, it is possible to shorten the cutting time, and the angularity of the second contact face 432a with the first contact face 431a can be obtained with higher accuracy.

The turning tool 54 changes the direction of approach between the upper surface of the base portion 431 and the outer circumferential face of the positioning portion 432. By the rotation of the turning tool 54 at this time, a clearance portion 434 is formed in a boundary portion between the upper surface of the base portion 431 and the outer circumferential face of the positioning portion 432. The clearance portion 434 is a recessed portion which is recessed in a direction separated away from the first contact face 431a, the second contact face 432a, and the disc 21 shown in FIG. 2. With this configuration, the direction of the turning tool 54 can be changed in the boundary portion between the first contact face and the second contact face, so that the cutting can be performed efficiently.

The cutting device 50 generates a magnetic flux in the coil 531 of the device-side stator 53 in a condition where the outer circumferential surface of the sleeve 32 is chucked. Due to the torque between the device-side stator 53 and the rotor magnet 46, the shaft 41, the hub member 42, and the disc-support member 43 are rotated.

With this configuration, as compared with the case where the shaft 41 or the hub member 42 is held and rotated, the disc-support member 43 can be cut with the suppressed run-out. In addition, since the run-out of the first contact face 431a can be suppressed with high accuracy, the disc 21 can be stably rotated in the circumferential direction, and the lifted amount of the head 221 (see FIG. 1) can be stabled.

In steps S53 to S54, preferably, the shaft 41, the hub member 42, and the disc-support member 43 are rotated with a torque larger than that obtained in the driving as the spindle motor 1. Specifically, it is preferred that a magnetic flux larger than the magnetic flux generated in the stator core 33 in the driving as the spindle motor 1 be generated in the device-side stator 53, so as to rotate the shaft 41, the hub member 42, and the disc-support member 43. With such a configuration, the vibration of the turning tool 54 or the disc-support member 43 due to the cutting resistance is further suppressed, and the first contact face 431a and the second contact face 432a can be more accurately formed.

In addition, the shaft 41, the hub member 42, and the disc-support member 43 are preferably rotated at a rotation speed different from that in the driving as the spindle motor 1. With such a configuration, the disc-support member 43 can be cut at a cutting speed suitable for the resin material constituting the disc-support member 43. In addition, it is possible to prevent the characteristic frequency of the disc-support member 43 and the characteristic frequency of the turning tool 54 from being matched with each other, so that the deterioration of surface roughness of the first contact face 431a and the second contact face 432a due to the resonance can be prevented.

The rotation speed of the shaft 41, the hub member 42, and the disc-support member 43 is preferably lower than that in the driving as the spindle motor 1. With this configuration, the deterioration of surface roughness of the first contact face 431a and the second contact face 432a due to the resonance can be suppressed, and shavings of the disc-support member 43 generated by the cutting can be continuously formed as swatch, and thus the generation of dust by the cutting can be suppressed.

In this manufacturing process, the cutting of the disc-support member 43 is performed before the fixed frame 31 is attached to the sleeve 32. Accordingly, the cleaning, the wiping of shavings, and the like of the members constituting the spindle motor after the cutting can be easily performed, so that it is possible to prevent the shavings generated in the cutting from remaining in the interior of the spindle motor 1.

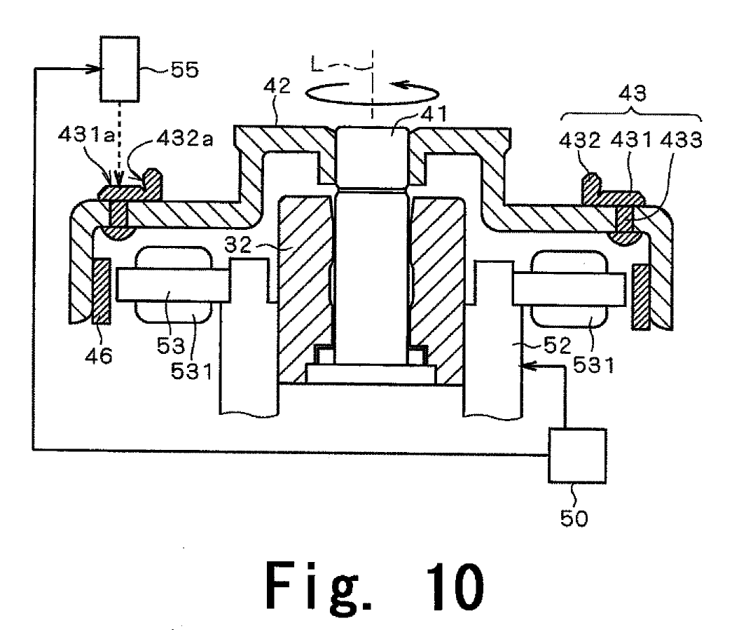

Referring back to FIG. 5, after the cutting of the disc-support member 43 is finished, the cutting device 50 measures the run-out of the first contact face 431a while the rotation of the shaft 41, the hub member 42, and the disc-support member 43 is maintained (step S6, and see FIG. 10).

Specifically, by a non-contact sensor 55 disposed above the disc-support member 43 and opposed to the disc-support member 43 with a gap interposed therebetween, the height of the first contact face 431a is continuously detected. In this way, the run-out of the first contact face 431a synchronous with the rotation of the disc-support member 43 is measured. In other words, RRO (Repeatable Run Out) of the disc-support member 43 in the axial direction is measured. More specifically, the width of the first contact face 431a moving in a direction perpendicular to the first contact face 431a (i.e., a direction parallel to the center axis L) during the rotation of the motor is measured.

The manufacturer checks the accuracy of run-out of the first contact face 431a, so that it is possible to prevent a product out of the specified range from being moved to the next process step. In addition, the manufacturer can sense the degree of degradation of the turning tool based on the result measured by the non-contact sensor 55.

The non-contact sensor 55 is installed on the cutting device 50, and constitutes part of the cutting device 50. Accordingly, it is possible to continuously and efficiently perform the cutting of the disc-support member 43 and the measurement of the run-out. In step S6, in addition to the accuracy of run-out of the first contact face 431a, the accuracy of run-out of the second contact face 432a may also be measured.

Thereafter, the manufacturer attaches the fixed frame 31 to the sleeve 32 (step S7). The manufacturer inserts the sleeve 32 into the frame through hole 312 of the fixed frame 31 furnished with the stator core 33 and the coil 34, and fixes the sleeve 32 and the fixed frame 31 by means of press fit, shrinkage fit, bonding, or the like. Then, the manufacturer performs various inspections and checking of operations if necessary, thereby completing the manufacturing of the spindle motor 1.

One preferred embodiment of the present invention is described above, but the present invention is not limited to the above-described preferred embodiment.

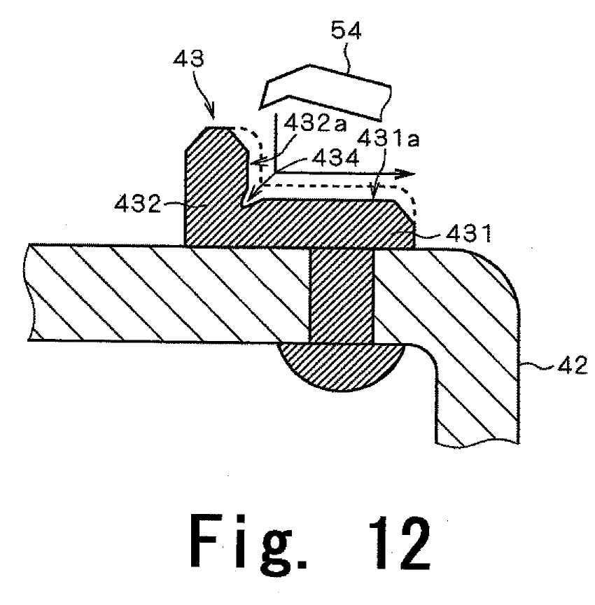

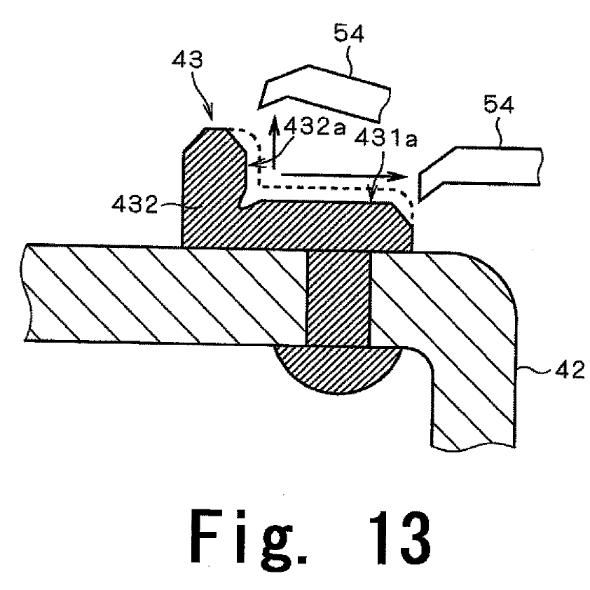

For example, in step S54, the turning tool 54 performs the cutting for the disc-support member 43 via the approaching route shown in FIG. 11. The present invention is not limited to this. Alternatively, the cutting may be performed for the disc-support member 43 via the approaching routes shown in FIG. 12 or 13, for example.

In the example shown in FIG. 12, preferably, the turning tool 54 first performs the cutting of the outer circumferential face of the positioning portion 432 from the top to the bottom thereof in the axial direction, and thereafter performs the cutting of the upper surface of the base portion 431 from the inside to the outside in the radial direction.

In the example shown in FIG. 13, preferably, the turning tool 54 performs the cutting of the upper surface of the base portion 431 from the inside to the outside in the radial direction from the boundary portion between the base portion 431 and the positioning portion 432, and also performs the cutting of the outer circumferential face of the positioning portion 432 from the bottom to the top in the axial direction from the boundary portion between the base portion 431 and the positioning portion 432.

In another preferred example, for example, the cutting is performed for one of the upper surface of the base portion 431 and the outer circumferential face of the positioning portion 432 from the starting point of the boundary portion between the base portion 431 and the positioning portion 432, and thereafter, the cutting is performed for the other one from a position distant from the boundary portion toward the boundary portion.

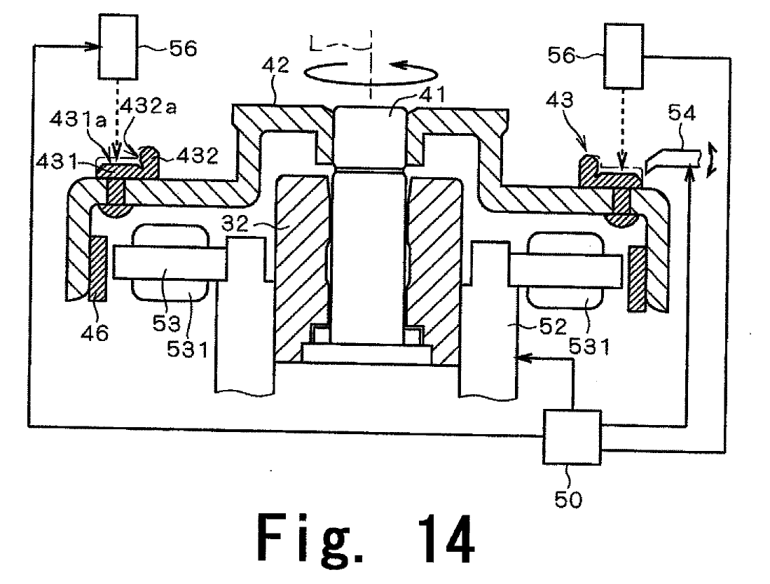

Moreover, in the above-described cutting in step S54, the inclination of the disc-support member 43 from the center axis L is measured by a plurality of (three, for example) non-contact type sensors 56 as shown in FIG. 14, and the approaching direction of the turning tool 54 may be controlled based on the detected results. With this configuration, the cutting can be performed at an optimal angle in accordance with the inclination of the disc-support member 43 from the center axis L. Accordingly, the cutting can be performed for the disc-support member 43 with higher degree of accuracy. The plurality of non-contact sensors 56 may detect the height of the surface of the disc-support member 43 as shown in FIG. 14. Alternatively, the plurality of non-contact sensors 56 may detect the height of the surface of the hub member 42, so that the inclination of the disc-support member 43 from the center axis L can be measured indirectly.

In the above-described manufacturing method, the first contact face 431a and the second contact face 432a are obtained by cutting the surface of the disc-support member 43. Accordingly, it is possible to employ a hub member 42 which is obtained by any one of various manufacturing methods. In other words, instead of the hub member 42 obtained by pressing the metal member, a hub member obtained by any one of various manufacturing methods such as forging, molding, and cutting can be used.

In the above-described preferred embodiment, the thermoplastic resin is used as the material constituting the disc-support member 43. However, the material constituting the disc-support member 43 may be selected from materials having a cutting resistance smaller than that of the material constituting the hub member. Accordingly, as the material constituting the disc-support member 43, it is possible to use another material which has a cutting resistance smaller than that of a usual metal material, and from which a smooth cut face can be obtained. For example, preferably, the hub member 42 may be formed from austenitic stainless steel, and the disc-support member 43 may be formed from a metal member having superior cutting properties than the austenitic stainless steel (brass, for example).

Even in the case where the thermoplastic resin is used, instead of polyacetal or nylon, engineering plastic such as liquid crystal polymer (LCP) may be used.

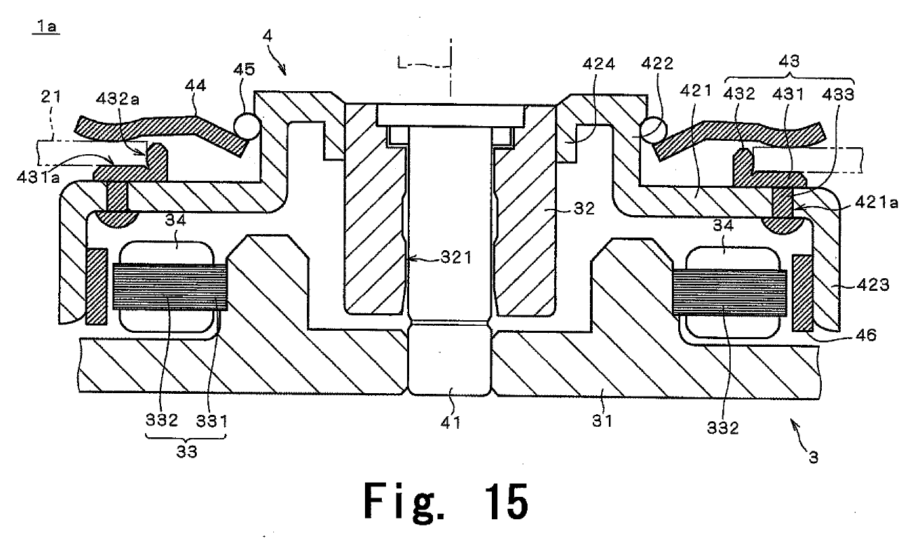

In the above-described preferred embodiment, the spindle motor 1 in which the shaft rotates is described. The present invention is not limited to this. The present invention can be applied to a spindle motor in which a shaft is fixed to a frame as shown in FIG. 15. FIG. 15 is a view showing an example of a spindle motor 1a. In the spindle motor 1a shown in FIG. 15, the shaft 41 is fixed to the fixed frame 31, and constitutes part of the stationary assembly 3. In addition, the sleeve 32 is fixed to the hub member 42, and constitutes part of the rotor assembly 4. Other configurations of the spindle motor 1a are the same as those in the above-described spindle motor 1, so that they are designated by the identical reference numerals and the descriptions thereof are omitted.

As for the above-described spindle motor 1, the magnetic disc 21 is rotated. Alternatively, another type of storage medium such as an optical disc may be rotated.

The above-described disk driver 2 is a hard disk driver furnished with the disc 21 as the component thereof. The present invention is not limited to this. The disk driver 2 is not necessarily furnished with a disc. For example, the disk driver of the present invention may be an optical disk driver onto which an optical disc such as CD-ROM, CD-R, CD-RW, DVD-ROM, or the like is loaded in use.

The spindle motor to which the present invention is applied is a motor in which the rotor magnet 46 is disposed on the radially outer side than the stator core 33 and the coil 34. The present invention is not limited to this. Alternatively, the spindle motor may be a motor in which the rotor magnet is disposed on the radially inner side than the stator core and the coil.

As the bearing unit, for example, a gas dynamic-pressure bearing in which a gas is used as a fluid may be employed.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A manufacturing method of a disk-driving spindle motor for rotating a disc (21) having a hole at the center thereof, comprising:
a disposing step of disposing a hub member (42) rotating about a center axis and radially spreading around the center axis, and disposing a disc-support member (43) including a base portion (431) disposed around the center axis and a positioning portion (432) protruding axially upwardly from the base portion (431), the disc-support member being made from a material having a smaller cutting resistance than that of a material from which the hub member (42) is made;
a fixing step of fixing the disc-support member (43) to the hub member (42); and
a cutting step of cutting an upper surface of the base portion (431), thereby obtaining a first contact face (431a) which is in contact with a lower surface of the disc (21), and cutting an outer circumferential face of the positioning portion (432), thereby obtaining a second contact face (432a) which is in contact with an inner circumferential face or an inner circumferential rim of the disc (21), while the hub member (42) is being rotated about the center axis.

2. A manufacturing method of a disk-driving spindle motor according to claim 1, wherein
in the cutting step, between the first contact face (431a) and the second contact face (432a), a recessed portion (434) which is continuous to the first contact face (431a) and the second contact face (432a) and recessed in a direction separated away from the disc (21).

3. A manufacturing method of a disk-driving spindle motor according to claim 1, wherein
in the cutting step, after the upper surface of the base portion (431) is cut from the outer side to the inner side in a radial direction with respect to the center axis, the outer circumferential face of the positioning portion (432) is cut from the lower side to the upper side in an axial direction, thereby obtaining the first contact face (431a) and the second contact face (432a).

4. A manufacturing method of a disk-driving spindle motor according to claim 1, wherein
in the cutting step, after the outer circumferential face of the positioning portion (432) is cut from the upper side to the lower side in the axial direction, the upper surface of the base portion (431) is cut from the inner side to the outer side in the radial direction, thereby obtaining the first contact face (431a) and the second contact face (432a).

5. A manufacturing method of a disk-driving spindle motor according to claim 1, wherein
in the cutting step, the disc-support member (43) is cut from a boundary portion between the base portion (431) and the positioning portion (432) to the radially outer side or to the axially upper side, thereby obtaining at least one of the first contact face (431a) and the second contact face (432a).

6. A manufacturing method of a disk-driving spindle motor according to claim 1, wherein
in the cutting step, the upper surface of the base portion (431) and the outer circumferential face of the positioning portion (432) are continuously cut by means of one cutting tool (54).

7. A manufacturing method of a disk-driving spindle motor according to claim 1, wherein in the disposing step, the hub member (42) is obtained by pressing a metal member.

8. A manufacturing method of a disk-driving spindle motor according to claim 1, wherein in the disposing step, the disc-support member (43) is made from a resin material.

9. A manufacturing method of a disk-driving spindle motor according to claim 1, further comprising, after the cutting step, a measuring step of measuring run-out of the first contact face (431a), while the hub member 42 is being rotated about the center axis, the run-out being synchronous with the rotation.

10. A manufacturing method of a disk-driving spindle motor according to claim 9, wherein
in the cutting step, the disc-support member (43) is cut by means of a predetermined cutting device, and
in the measuring step, the run-out of the first contact face (431a) is measured by a sensor mounted on the cutting device.

11. A manufacturing method of a disk-driving spindle motor according to claim 1, further comprising, before the cutting step, a bearing-unit attaching step of attaching a bearing unit (5) as part of the spindle motor to the hub member (42) in a relatively rotatable manner, wherein
in the cutting step, in a condition where the bearing unit (5) is fixed to a predetermined chuck portion, the disc-support member (43) is cut while the hub member (42) is being rotated about the center axis.

12. A manufacturing method of a disk-driving spindle motor according to claim 11, further comprising, before the cutting step, a positioning step of positioning the hub member (42) with respect to the chuck portion (52), by causing the hub member (42) to abut against a reference plane (51a) having a known positional relationship with the chuck portion (52).

13. A manufacturing method of a disk-driving spindle motor according to claim 1, wherein
a rotor magnet (46) is fixed to the hub member (42), and
in the cutting step, the disc-support member (43) is cut, while the hub member (42) is being rotated due to a torque generated between the rotor magnet (46) and a device-side stator (53) opposite to the rotor magnet (46), the torque being larger than that in the driving of the spindle motor.

14. A manufacturing method of a disk-driving spindle motor according to claim 1, wherein in the cutting step, the disc-support member (43) is cut, while the hub member (42) is being rotated at a rotation speed different from that in the driving of the spindle motor.

15. A manufacturing method of a disk-driving spindle motor according to claim 1, wherein in the cutting step, the inclination of the center axis is detected, and the cutting direction is controlled based on the detected result.

16. A manufacturing method of a disk-driving spindle motor according to claim 1, further comprising:
a stationary assembly (3);
a rotor assembly (4) having the hub member (42) rotating about the center axis with respect to the stationary assembly (3) and the disc-support member (43) for supporting the disc (21); and
a driving section for generating a torque between the stationary assembly (3) and the rotor assembly (4).

17. A disc-driving spindle motor for rotating a disc (21) having a hole at the center thereof, comprising:
a stationary assembly (3);
a hub member (42) radially spreading around a center axis;
a bearing unit (5) for supporting the hub member (42) in a relatively rotatable manner with respect to the stationary assembly (3); and
a disc-support member (43), fixed to the hub member (42), for supporting the disc (21), the disc-support member (43) including a base portion (431) disposed around the center axis, the base portion (431) being in contact with a lower surface of the disc (21) and a positioning portion (432) which extends to an axially upper side from the base portion (431) and is disposed around the center axis, the positioning portion (432) being in contact with an inner circumferential face or an inner circumferential rim of the disc (21), wherein
the disc-support member (43) is made from a material having a cutting resistance smaller than that of a material from which the hub member (42) is made.

18. A disk-driving spindle motor according to claim 17, wherein
the hub member (42) includes a first cylindrical portion (422) positioned on a radially inner side than the positioning portion (432), and
the positioning portion is opposed to the first cylindrical portion (422) with a radial gap interposed therebetween.

19. A disk-driving spindle motor according to claim 17, wherein the base portion (431) and the positioning portion (432) are made from a resin material.

20. A disk-driving spindle motor according to claim 19, wherein the resin material substantially contains no filler.

21. A disk-driving spindle motor according to claim 17, wherein
the base portion (431) is fixed to the hub member (42) in a lower portion of the base portion (431), and
the positioning portion (432) is positioned in a radially inner side than a portion (near 433) of the hub member (42) which is fixed to the hub member (42).

22. A disk-driving spindle motor according to claim 21, wherein the base portion (431) is fixed to the hub member (42) by thermal welding.

23. A disk-driving spindle motor according to claim 17, wherein a portion (431a) of the base portion (431) which is in contact with a lower surface of the disc (21) is continuous in a circumferential direction and makes a round about the center axis, and
a portion (432a) of the positioning portion (432) which is in contact with an inner circumferential face or an inner circumferential rim of the disc (21) is continuous in the circumferential direction and makes a round about the center axis.

24. A disk driver for rotating a disc (21), comprising:
a housing (23);
a disk-driving spindle motor (1) according to claim 17, disposed in the inside of the housing (23), for rotating the disc (21); and
an access unit for writing or reading information into or from a desired position of the disc (21).
